(19) United States
(12) Patent Application Publication
(10) Pub. No.: US 2015/0171474 A1
(43) Pub. Date: Jun. 18, 2015

(54) Lithium-Ion Secondary Battery And Electrolyte Thereof

(71) Applicant: Ningde Amperex Technology Limited, Ningde (CN)

(72) Inventors: Chunbo CHU, Ningde (CN); Chenghua FU, Ningde (CN)

(21) Appl. No.: 14/559,761

(22) Filed: Dec. 3, 2014

(30) Foreign Application Priority Data
Dec. 12, 2013 (CN) 201310674441.5

(51) Int. Cl. H01M 10/0567; H01M 10/0525

(52) U.S. Cl. CPC H01M 10/0567; H01M 10/0525; H01M 2300/004; H01M 4/131

(57) ABSTRACT

The present disclosure provides a lithium-ion secondary battery and an electrolyte thereof. The electrolyte of the lithium-ion secondary battery comprises a lithium salt; a non-aqueous solvent and an additive. The additive comprises a first additive and a second additive, the first additive is 1,3-propane sultone (PS), the second additive is 4-methylene-1,3-dioxolan-2-one and its derivatives with a structural formula 1 and/or 4,5-dimethylene-1,3-dioxolan-2-one and its derivatives with a structural formula 2; in the structural formula 1 and the structural formula 2, R₁, R₂, R₃ and R₄ each are hydrogen, halogen, C1˜C3 alkyl or halogenated alkyl; a weight percentage of the first additive in the electrolyte is 0.3%-4.0%, a weight percentage of the second additive in the electrolyte is 0.3%-4.0%. The lithium-ion secondary battery comprises the aforementioned electrolyte. The lithium-ion secondary battery of the present disclosure has better low temperature discharging performance.

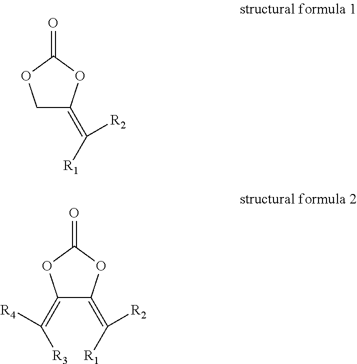

### REFERENCE TO RELATED APPLICATIONS

The present disclosure claims priority to Chinese Patent Application No. CN201310674441.5 filed on Dec. 12, 2013, the content of which is fully incorporated in its entirety herein.

### FIELD OF THE PRESENT DISCLOSURE

The present disclosure relates to a field of a battery, and particularly to a lithium-ion secondary battery and an electrolyte thereof.

### BACKGROUND OF THE PRESENT DISCLOSURE

Although a lithium-ion secondary battery has advantages such as high working voltage, long service life and fast charging speed and the like, with development of technology and people's demand for fast and convenient electronic products, the lithium-ion secondary battery is required to have better cycle performance and is also required to be capable of quickly discharging in condition of lower temperature.

In practice, cyclic carbonate ester and chain carbonate ester are usually used as solvent, but the solvent is continuously oxidized or reduced during charging-discharging process of the lithium-ion secondary battery, the cycle performance of the lithium-ion secondary battery is deteriorated. The cycle performance and the storage performance of the lithium-ion secondary battery in U.S. Pat. No. 6,033,809 are improved by adding 1,3-propane sultone (PS) into the electrolyte thereof. However, a too thick SEI film will be formed on the surface of the negative electrode plate by adding 1,3-propane sultone (PS), impedance of the SEI film is increased, thereby deteriorating the discharging performance in condition of low temperature of the lithium-ion secondary battery.

Chinese patent application publication No. CN101755354A discloses a method of forming a SEI film on a surface of a negative electrode plate, the cycle performance of the lithium-ion secondary battery is improved by adding 4-methylene-1,3-dioxolan-2-one into the electrolyte thereof, but the low temperature discharging performance is not mentioned in this patent document.

Therefore, it is necessary to provide a lithium-ion secondary battery and an electrolyte thereof, which has better discharging performance in condition of low temperature.

### SUMMARY OF THE PRESENT DISCLOSURE

In view of the problems existing in the background technology, an object of the present disclosure is to provide a lithium-ion secondary battery and an electrolyte thereof, the lithium-ion secondary battery has better low temperature discharging performance.

In order to achieve the above objects, in a first aspect of the present disclosure, the present disclosure provides an electrolyte of a lithium-ion secondary battery which comprises: a HI lithium salt; a non-aqueous solvent; and an additive; the additive comprises a first additive and a second additive, the first additive is 1,3-propane sultone (PS), the second additive is 4-methylene-1,3-dioxolan-2-one and its derivatives with a structural formula 1 and/or 4,5-dimethylene-1,3-dioxolan-2-one and its derivatives with a structural formula 2; in the structural formula 1 and the structural formula 2, R₁, R₂, R₃ and R₄ each are hydrogen, halogen, C1˜C3 alkyl or halogenated alkyl; a weight percentage of the first additive in the electrolyte of the lithium-ion secondary battery is 0.3%˜4.0%, a weight percentage of the second additive in the electrolyte of the lithium-ion secondary battery is 0.3%˜4.0%.

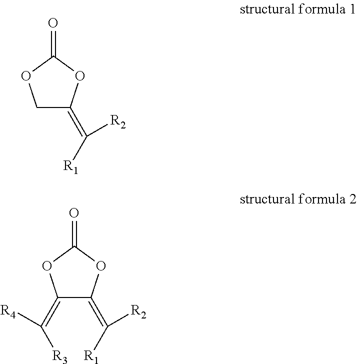

In a second aspect of the present disclosure, the present disclosure provides a lithium-ion secondary battery which comprises: a positive electrode plate; a negative electrode plate; a separator interposed between the positive electrode plate and the negative electrode plate; and an electrolyte. The electrolyte is the electrolyte according to the first aspect of the present disclosure.

The present disclosure has following beneficial effects:

In the electrolyte of the present disclosure, by adding the first additive and the second additive, the composite SEI film, which is good for lithium ion transfer, can be formed on the surface of the negative electrode plate of the lithium-ion secondary battery, therefore the lithium-ion secondary battery has better low temperature discharging performance.

### DETAILED DESCRIPTION

Hereinafter a lithium-ion secondary battery and an electrolyte thereof and a preparation method thereof according to the present disclosure are described in detail.

Firstly an electrolyte of a lithium-ion secondary battery according to a first aspect of the present disclosure is described, which comprises: a lithium salt; a non-aqueous solvent; and an additive, the additive comprises a first additive and a second additive. The first additive is 1,3-propane sultone (PS), the second additive is 4-methylene-1,3-dioxolan-2-one and its derivatives with a structural formula 1 and/or 4,5-dimethylene-1,3-dioxolan-2-one and its derivatives with a structural formula 2; in the structural formula 1 and the structural formula 2, R₁, R₂, R₃ and R₄ each are hydrogen, halogen, C1˜C3 alkyl or halogenated alkyl, a weight percentage of the first additive in the electrolyte of the lithium-ion secondary battery is 0.3%˜4.0%, a weight percentage of the second additive in the electrolyte of the lithium-ion secondary battery is 0.3%˜4.0%. Specifically, when the second additive is only 4-methylene-1,3-dioxolan-2-one and its derivatives with the structural formula 1, the weight percentage of 4-methylene-1,3-dioxolan-2-one and its derivatives with the structural formula 1 in the electrolyte of the lithium-ion secondary battery is 0.3%˜4.0%; when the second additive is only 4,5-dimethylene-1,3-dioxolan-2-one and its derivatives with the structural formula 2, the weight percentage of 4,5-dimethylene-1,3-dioxolan-2-one and its derivatives with the structural formula 2 in the electrolyte of the lithium-ion secondary battery is 0.3%˜4.0%; when the second additive is 4-methylene-1,3-dioxolan-2-one and its derivatives with the structural formula 1 and 4,5-dimethylene-1,3-dioxolan-2-one and its derivatives with the structural formula 2, the overall weight percentage of 4-methylene-1,3-dioxolan-2-one and its derivatives with the structural formula 1 and 4,5-dimethylene-1,3-dioxolan-2-one and its derivatives with the structural formula 2 in the electrolyte of the lithium-ion secondary battery is 0.3%˜4.0%.

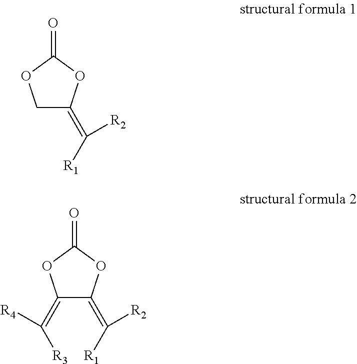

In the electrolyte of the lithium-ion secondary battery according to the first aspect of the present disclosure, by that 1,3-propane sultone (PS) and 4-methylene-1,3-dioxolan-2-one and its derivatives and/or 4,5-dimethylene-1,3-dioxolan-2-one and its derivatives are added into the electrolyte of the lithium-ion secondary battery, the obtained lithium-ion secondary battery has better low temperature discharging performance. This is because 4-methylene-1,3-dioxolan-2-one and its derivatives and/or 4,5-dimethylene-1,3-dioxolan-2-one and its derivatives have (has) a higher reduction potential than 1,3-propane sultone (PS), the potential of the negative electrode plate is changed from high to low as the formation charging, 4-methylene-1,3-dioxolan-2-one and its derivatives and/or 4,5-dimethylene-1,3-dioxolan-2-one and its derivatives preferentially form a layer of SEI film with lower impedance on the surface of the negative electrode plate, then 1,3-propane sultone (PS) forms another SEI film on the above SEI film. In comparison with the SEI film which is formed on the surface of the negative electrode plate only by 4-methylene-1,3-dioxolan-2-one and its derivatives and/or 4,5-dimethylene-1,3-dioxolan-2-one and its derivatives, the composite SEI film which is formed by 1,3-propane sultone (PS) and 4-methylene-1,3-dioxolan-2-one and its derivatives and/or 4,5-dimethylene-1,3-dioxolan-2-one and its derivatives is more stable, which prevents further reduction reactions of 4-methylene-1,3-dioxolan-2-one and its derivatives and/or 4,5-dimethylene-1,3-dioxolan-2-one and its derivatives or 1,3-propane sultone (PS) on the surface of the negative electrode plate, and the formed SEI film is better for the lithium ion transfer in condition of low temperature, and the lithium-ion secondary battery has better low temperature discharging performance. When the electrolyte of the lithium-ion secondary battery only consists of 4-methylene-1,3-dioxolan-2-one and its derivatives and/or 4,5-dimethylene-1,3-dioxolan-2-one and its derivatives, the stability of the formed SEI film is worse, and oxidation-reduction reactions are continually generated on the surface of the negative electrode plate, therefore the formed SEI film is too thick and the low temperature discharging performance of the lithium-ion secondary battery is worse. When the electrolyte of the lithium-ion secondary battery only consists of 1,3-propane sultone (PS), the formed SEI film is relatively compact, therefore the transfer performance of the lithium ions is worse and the low temperature discharging performance of the lithium-ion secondary battery is also worse.

In the electrolyte of the lithium-ion secondary battery according to the first aspect of the present disclosure, if the weight percentage of 1,3-propane sultone (PS) and 4-methylene-1,3-dioxolan-2-one and its derivatives and/or 4,5-dimethylene-1,3-dioxolan-2-one and its derivatives in the electrolyte is too high (the weight percentage of the first additive in the electrolyte is more than 4.0%, the weight percentage of the second additive in the electrolyte is more than 4.0%), C═C of 4-methylene-1,3-dioxolan-2-one and its derivatives and/or 4,5-dimethylene-1,3-dioxolan-2-one and its derivatives will form a too thick SEI film by polymerizing, the impedance of the lithium-ion secondary battery is increased, thereby affecting the transfer performance of the lithium ions and reducing the low temperature discharging performance of the lithium-ion secondary battery; similarly, too much 1,3-propane sultone (PS) will also form a too thick and compact SEI film, the impedance of the lithium-ion secondary battery is increased, thereby affecting the transfer performance of the lithium ions and reducing the low temperature discharging performance of the lithium-ion secondary battery. If the weight percentage of 1,3-propane sultone (PS) and 4-methylene-1,3-dioxolan-2-one and its derivatives and/or 4,5-dimethylene-1,3-dioxolan-2-one and its derivatives in the electrolyte is too low (the weight percentage of the first additive in the electrolyte is less than 0.3%, the weight percentage of the second additive in the electrolyte is less than 0.3%), C═C of 4-methylene-1,3-dioxolan-2-one and its derivatives and/or 4,5-dimethylene-1,3-dioxolan-2-one and its derivatives cannot form an effective and compact SEI film, and cannot prevent the reactions between the electrolyte of the lithium-ion secondary battery and the negative electrode plate, the transfer performance of the lithium ions of the formed SEI film is worse, thereby reducing the low temperature discharging performance of the lithium-ion secondary battery; similarly, reducing the weight percentage of 1,3-propane sultone (PS) which is used to form the SEI film will also make the stability of the SEI film worse, and cannot effectively prevent the reduction reactions on the surface of the negative electrode of 1,3-propane sultone (PS), the impedance of the lithium-ion secondary battery is increased, thereby affecting the transfer performance of the lithium ions and reducing the low temperature discharging performance of the lithium-ion secondary battery.

In the electrolyte of the lithium-ion secondary battery according to the first aspect of the present disclosure, the lithium salt may comprise at least one of LiN(CₓF₂ₓ₊₁ SO₂)(C_{y}F_{2y+1} SO₂) (where x, y is positive integer), LiPF₆, LiBF₄, LiBOB, LiAsF₆, Li(CF₃SO₂)₂N, LiCF₃SO₃ and LiClO₄.

In the electrolyte of the lithium-ion secondary battery according to the first aspect of the present disclosure, a concentration of the lithium salt may be 0.5M˜2M.

In the electrolyte of the lithium-ion secondary battery according to the first aspect of the present disclosure, the non-aqueous solvent may comprise a combination of a cyclic carbonate ester and a chain carbonate ester. The cyclic carbonate ester has a higher dielectric constant, and can effectively react with lithium ions to form a solvated lithium ion; the chain carbonate ester has a lower viscosity and is good for the transfer of the lithium ions and can improve the low temperature performance of the electrolyte.

In the electrolyte of the lithium-ion secondary battery according to the first aspect of the present disclosure, the cyclic carbonate ester may comprise at least one of ethylene carbonate (EC), propylene carbonate (PC), γ-butyrolactone (GBL) and 2,3-butylene carbonate (BC); the chain carbonate ester may comprise at least one of dimethyl carbonate (DMC), diethyl carbonate (DEC), dipropyl carbonate (DPC), ethyl methyl carbonate (EMC), methyl propyl carbonate (MPC) and ethyl propyl carbonate (EPC).

In the electrolyte of the lithium-ion secondary battery according to the first aspect of the present disclosure, a weight percentage of the cyclic carbonate ester in the electrolyte of the lithium-ion secondary battery may be 10%˜70%; a weight percentage of the chain carbonate ester in the electrolyte of the lithium-ion secondary battery may be 15%˜80%.

In the electrolyte of the lithium-ion secondary battery according to the first aspect of the present disclosure, preferably, the weight percentage of the first additive in the electrolyte of the lithium-ion secondary battery may be 0.5%˜2.0%.

In the electrolyte of the lithium-ion secondary battery according to the first aspect of the present disclosure, preferably, the weight percentage of the second additive in the electrolyte of the lithium-ion secondary battery may 0.5%˜3.0%. Specifically, when the second additive is only 4-methylene-1,3-dioxolan-2-one and its derivatives with the structural formula 1, the weight percentage of 4-methylene-1,3-dioxolan-2-one and its derivatives with the structural formula 1 in the electrolyte of the lithium-ion secondary battery is 0.5%˜3.0%; when the second additive is only 4,5-dimethylene-1,3-dioxolan-2-one and its derivatives with the structural formula 2, the weight percentage of 4,5-dimethylene-1,3-dioxolan-2-one and its derivatives with the structural formula 2 in the electrolyte of a lithium-ion secondary battery is 0.5%˜3.0%; when the second additive is 4-methylene-1,3-dioxolan-2-one and its derivatives with the structural formula 1 and 4,5-dimethylene-1,3-dioxolan-2-one and its derivatives with the structural formula 2, the overall weight percentage of 4-methylene-1,3-dioxolan-2-one and its derivatives with the structural formula 1 and 4,5-dimethylene-1,3-dioxolan-2-one and its derivatives with the structural formula 2 in the electrolyte of a lithium-ion secondary battery is 0.5%˜3.0%.

In the electrolyte of the lithium-ion secondary battery according to the first aspect of the present disclosure, at least one of R₁ and R₂ may be fluorine (F).

Next a lithium-ion secondary battery according to a second aspect of the present disclosure is described, which comprises: a positive electrode plate; a negative electrode plate; a separator interposed between the positive electrode plate and the negative electrode plate; and an electrolyte. The electrolyte is the electrolyte according to the first aspect of the present disclosure.

Then examples and comparative examples of the lithium-ion secondary battery and the electrolyte thereof and the preparation method thereof according to the present disclosure are described.

### Example 1

### (1) Preparation of a Positive Electrode Plate of a Lithium-Ion Secondary Battery

LiCoO₂ as active material, super-P as conductive material and PVDF as binder, in a weight ratio of 96:2:2, were uniformly mixed with N-methyl pyrrolidone (NMP) as solvent to form a positive electrode slurry of the lithium-ion secondary battery, the positive electrode slurry was then coated on aluminum foil as current collector, baking was then performed at 85° C., which was followed by cold pressing; then after edge-trimming, plate cutting, slitting, baking at 85° C. for 4 h under vacuum, and welding a tab, the positive electrode plate of the lithium-ion secondary battery was obtained.

### (2) Preparation of a Negative Electrode Plate of a Lithium-Ion Secondary Battery

Graphite as active material, super-P as conductive material, CMC as thickening agent and SBR as binder, in a weight ratio of 96.5:1.0:1.0:1.5, were uniformly mixed with deionized water as solvent to form a negative electrode slurry, the negative electrode slurry was then coated on copper foil as current collector, baking was then performed at 85° C., which was followed by edge-trimming, plate cutting, slitting, baking at 110° C. for 4 h under vacuum, and welding a tab, the negative electrode plate of the lithium-ion secondary battery was obtained.

### (3) Preparation of an Electrolyte of a Lithium-Ion Secondary Battery

The electrolyte of the lithium-ion secondary battery used a concentration of 1M of LiPF₆ as lithium salt, and used a mixture of ethylene carbonate (EC), propylene carbonate (PC) and diethyl carbonate (DEC), in a weight ratio of 30:30:40, as non-aqueous organic solvent. Furthermore, the electrolyte further contained an additive, which consisted of 0.3 wt % of 1,3-propane sultone (PS) and 0.3 wt % of 4-methylene-1,3-dioxolan-2-one.

### (4) Preparation of a Lithium-Ion Secondary Battery

The obtained positive electrode plate and the negative electrode plate of the lithium-ion secondary battery were wound together with PE membrane as separator to form a cell having a thickness of 4.2 mm, a width of 34 mm, and a length of 82 mm, then baking was performed at 75° C. for 10 h under vacuum, which was followed by injection of the prepared electrolyte and standby for 24 h, then charging was performed at a constant current of 0.1 C (160 mA) to 4.2V, then charging was performed at a constant voltage of 4.2V to a current of 0.05 C (80 mA), and discharging was performed at a constant current of 0.1 C (160 mA) to 3.0V, the above charging and discharging process was repeated, which was followed by charging at a constant current of 0.1 C (160 mA) to 3.85V, and finally the preparation of the lithium-ion secondary battery was completed.

### Example 2

The lithium-ion secondary battery was prepared the same as that in example 1 except that in the preparation of the electrolyte of the lithium-ion secondary battery (step (3)), the additive consisted of 0.3 wt % of 1,3-propane sultone (PS) and 0.5 wt % of 4-methylene-1,3-dioxolan-2-one.

### Example 3

The lithium-ion secondary battery was prepared the same as that in example 1 except that in the preparation of the electrolyte of the lithium-ion secondary battery (step (3)), the additive consisted of 0.3 wt % of 1,3-propane sultone (PS) and 1.0 wt % of 4-methylene-1,3-dioxolan-2-one.

### Example 4

The lithium-ion secondary battery was prepared the same as that in example 1 except that in the preparation of the electrolyte of the lithium-ion secondary battery (step (3)), the additive consisted of 0.3 wt % of 1,3-propane sultone (PS) and 3.0 wt % of 4-methylene-1,3-dioxolan-2-one.

### Example 5

The lithium-ion secondary battery was prepared the same as that in example 1 except that in the preparation of the electrolyte of the lithium-ion secondary battery (step (3)), the additive consisted of 0.3 wt % of 1,3-propane sultone (PS) and 4.0 wt % of 4-methylene-1,3-dioxolan-2-one.

### Example 6

The lithium-ion secondary battery was prepared the same as that in example 1 except that in the preparation of the electrolyte of the lithium-ion secondary battery (step (3)), the additive consisted of 0.3 wt % of 1,3-propane sultone (PS) and 0.5 wt % of 4,5-dimethylene-1,3-dioxolan-2-one.

### Example 7

The lithium-ion secondary battery was prepared the same as that in example 1 except that in the preparation of the electrolyte of the lithium-ion secondary battery (step (3)), the additive consisted of 0.5 wt % of 1,3-propane sultone (PS) and 0.5 wt % of 4,5-dimethylene-1,3-dioxolan-2-one.

### Example 8

The lithium-ion secondary battery was prepared the same as that in example 1 except that in the preparation of the electrolyte of the lithium-ion secondary battery (step (3)), the additive consisted of 1.0 wt % of 1,3-propane sultone (PS) and 0.5 wt % of 4,5-dimethylene-1,3-dioxolan-2-one.

### Example 9

The lithium-ion secondary battery was prepared the same as that in example 1 except that in the preparation of the electrolyte of the lithium-ion secondary battery (step (3)), the additive consisted of 1.5 wt % of 1,3-propane sultone (PS) and 0.5 wt % of 4,5-dimethylene-1,3-dioxolan-2-one.

### Example 10

The lithium-ion secondary battery was prepared the same as that in example 1 except that in the preparation of the electrolyte of the lithium-ion secondary battery (step (3)), the additive consisted of 2.0 wt % of 1,3-propane sultone (PS) and 0.5 wt % of 4,5-dimethylene-1,3-dioxolan-2-one.

### Example 11

The lithium-ion secondary battery was prepared the same as that in example 1 except that in the preparation of the electrolyte of the lithium-ion secondary battery (step (3)), the additive consisted of 4.0 wt % of 1,3-propane sultone (PS) and 0.5 wt % of 4,5-dimethylene-1,3-dioxolan-2-one.

### Example 12

The lithium-ion secondary battery was prepared the same as that in example 1 except that in the preparation of the electrolyte of the lithium-ion secondary battery (step (3)), the additive consisted of 0.5 wt % of 1,3-propane sultone (PS) and 0.5 wt % of 4-methylene-1,3-dioxolan-2-one and 0.5 wt % of 4,5-dimethylene-1,3-dioxolan-2-one.

### Example 13

The lithium-ion secondary battery was prepared the same as that in example 1 except that in the preparation of the electrolyte of the lithium-ion secondary battery (step (3)), the additive consisted of 0.5 wt % of 1,3-propane sultone (PS) and 1.5 wt % of 4-methylene-1,3-dioxolan-2-one and 1.0 wt % of 4,5-dimethylene-1,3-dioxolan-2-one.

### Example 14

The lithium-ion secondary battery was prepared the same as that in example 1 except that in the preparation of the electrolyte of the lithium-ion secondary battery (step (3)), the additive consisted of 1.0 wt % of 1,3-propane sultone (PS) and 2.0 wt % of 4-methylene-1,3-dioxolan-2-one and 2.0 wt % of 4,5-dimethylene-1,3-dioxolan-2-one.

### Example 15

The lithium-ion secondary battery was prepared the same as that in example 1 except that in the preparation of the electrolyte of the lithium-ion secondary battery (step (3)), the additive consisted of 0.5 wt % of 1,3-propane sultone (PS) and 1.0 wt % of 4,5-dimethylene-1,3-dioxolan-2-one.

### Example 16

The lithium-ion secondary battery was prepared the same as that in example 1 except that in the preparation of the electrolyte of the lithium-ion secondary battery (step (3)), the additive consisted of 1.5 wt % of 1,3-propane sultone (PS) and 1.0 wt % of 4,5-diethylene-1,3-dioxolan-2-one.

### Example 17

The lithium-ion secondary battery was prepared the same as that in example 1 except that in the preparation of the electrolyte of the lithium-ion secondary battery (step (3)), the additive consisted of 0.5 wt % of 1,3-propane sultone (PS) and 1.0 wt % of 4-(3-fluoropropylene-1,3-dioxolan-2-one.

### Example 18

The lithium-ion secondary battery was prepared the same as that in example 1 except that in the preparation of the electrolyte of the lithium-ion secondary battery (step (3)), the additive consisted of 0.5 wt % of 1,3-propane sultone (PS) and 0.5 wt % of 4-fluoromethylene-1,3-dioxolan-2-one.

### Example 19

The lithium-ion secondary battery was prepared the same as that in example 1 except that in the preparation of the electrolyte of the lithium-ion secondary battery (step (3)), the additive consisted of 0.5 wt % of 1,3-propane sultone (PS) and 0.5 wt % of 4,5-difluoromethylene-1,3-dioxolan-2-one.

### Example 20

The lithium-ion secondary battery was prepared the same as that in example 1 except that in the preparation of the electrolyte of the lithium-ion secondary battery (step (3)), the additive consisted of 1.0 wt % of 1,3-propane sultone (PS) and 1.0 wt % of 4-fluoromethylene-1,3-dioxolan-2-one.

### Example 21

The lithium-ion secondary battery was prepared the same as that in example 1 except that in the preparation of the electrolyte of the lithium-ion secondary battery (step (3)), the additive consisted of 1.5 wt % of 1,3-propane sultone (PS) and 3.0 wt % of 4-fluoromethylene-1,3-dioxolan-2-one.

### Comparative Example 1

The lithium-ion secondary battery was prepared the same as that in example 1 except that in the preparation of the electrolyte of the lithium-ion secondary battery (step (3)) there was no additive.

### Comparative Example 2

The lithium-ion secondary battery was prepared the same as that in example 1 except that in the preparation of the electrolyte of the lithium-ion secondary battery (step (3)), the additive consisted of 2.0 wt % of 1,3-propane sultone (PS).

### Comparative Example 3

The lithium-ion secondary battery was prepared the same as that in example 1 except that in the preparation of the electrolyte of the lithium-ion secondary battery (step (3)), the additive consisted of 2.0 wt % of 4-methylene-1,3-dioxolan-2-one.

### Comparative Example 4

The lithium-ion secondary battery was prepared the same as that in example 1 except that in the preparation of the electrolyte of the lithium-ion secondary battery (step (3)), the additive consisted of 0.05 wt % of 1,3-propane sultone (PS) and 0.05 wt % of 4-methylene-1,3-dioxolan-2-one.

### Comparative Example 5

The lithium-ion secondary battery was prepared the same as that in example 1 except that in the preparation of the electrolyte of the lithium-ion secondary battery (step (3)), the additive consisted of 5.0 wt % of 1,3-propane sultone (PS) and 5.0 wt % of 4-methylene-1,3-dioxolan-2-one.

### Comparative Example 6

The lithium-ion secondary battery was prepared the same as that in example 1 except that in the preparation of the electrolyte of the lithium-ion secondary battery (step (3)), the additive consisted of 0.05 wt % of 1,3-propane sultone (PS) and 1.0 wt % of 4-methylene-1,3-dioxolan-2-one.

### Comparative Example 7

The lithium-ion secondary battery was prepared the same as that in example 1 except that in the preparation of the electrolyte of the lithium-ion secondary battery (step (3)), the additive consisted of 1.0 wt % of 1,3-propane sultone (PS) and 5.0 wt % of 4-methylene-1,3-dioxolan-2-one.

### Comparative Example 8

The lithium-ion secondary battery was prepared the same as that in example 1 except that in the preparation of the electrolyte of the lithium-ion secondary battery (step (3)), the additive consisted of 5.0 wt % of 1,3-propane sultone (PS) and 1.5 wt % of 4-methylene-1,3-dioxolan-2-one.

### Comparative Example 9

The lithium-ion secondary battery was prepared the same as that in example 1 except that in the preparation of the electrolyte of the lithium-ion secondary battery (step (3)), the additive consisted of 1.5 wt % of 1,3-propane sultone (PS) and 0.05 wt % of 4-methylene-1,3-dioxolan-2-one.

Finally tests and test results of examples 1-21 and comparative examples 1-9 of the lithium-ion secondary battery of the present disclosure were presented.

Test of the Low Temperature Discharging Performance

At 25° C., each of the lithium-ion secondary batteries was firstly charged to 4.2V at a constant current of 0.5 C (800 mA), and then charged to a current less than 0.05 C (80 mA) at a constant voltage of 4.2V, and then each of the lithium-ion secondary batteries was discharged to 3.0V at a constant current of 0.2 C (320 mA), the discharging capacity at 25° C. was obtained. At 25° C., each of the lithium-ion secondary batteries was then charged to 4.2V at a constant current of 0.5 C (800 mA), and then charged to a current less than 0.05 C (80 mA) at a constant voltage of 4.2V, and then at −20° C., each of the lithium-ion secondary batteries was placed for 2 h, then was discharged to 3.0V at a constant current of 0.2 C (320 mA), the discharging capacity at −20° C. was obtained.

The low temperature discharging performance of the lithium-ion secondary battery was evaluated by the low temperature capacity retention rate, the low temperature capacity retention rate was calculated as following:

Capacity retention rate at −20° C.=(the discharging capacity at −20° C./the discharging capacity at 25° C.)×100%

Next analysis of the low temperature discharging performance of the lithium-ion secondary battery of the present disclosure were presented.

Table 1 illustrated related parameters and test results of tests of examples 1-21 and comparative examples 1-9.

TABLE 1
Parameters and test results of tests of examples 1-21 and comparative examples 1-9

| | | | | | performances of |
|---|---|---|---|---|---|
| | | | | | lithium-ion secondary |
| | additive | | | | low temperature |
| | first additive | | second additive | | capacity retention rate |
| | type | content | type | content | −20° C. |
| example 1 | PS | 0.30% | 4-methylene-1,3-dioxolan-2-one | 0.30% | 26% |
| example 2 | PS | 0.30% | 4-methylene-1,3-dioxolan-2-one | 0.50% | 31% |
| example 3 | PS | 0.30% | 4-methylene-1,3-dioxolan-2-one | 1.00% | 36% |
| example 4 | PS | 0.30% | 4-methylene-1,3-dioxolan-2-one | 3.00% | 29% |
| example 5 | PS | 0.30% | 4-methylene-1,3-dioxolan-2-one | 4.00% | 26% |
| example 6 | PS | 0.30% | 4,5-dimethylene-1,3-dioxolan-2-one | 0.50% | 32% |
| example 7 | PS | 0.50% | 4,5-dimethylene-1,3-dioxolan-2-one | 0.50% | 35% |
| example 8 | PS | 1.00% | 4,5-dimethylene-1,3-dioxolan-2-one | 0.50% | 33% |
| example 9 | PS | 1.50% | 4,5-dimethylene-1,3-dioxolan-2-one | 0.50% | 31% |
| example 10 | PS | 2.00% | 4,5-dimethylene-1,3-dioxolan-2-one | 0.50% | 28% |
| example 11 | PS | 4.00% | 4,5-dimethylene-1,3-dioxolan-2-one | 0.50% | 25% |
| example 12 | PS | 0.50% | 4-methylene-1,3-dioxolan-2-one | 0.50% | 33% |
| | | | 4,5-dimethylene-1,3-dioxolan-2-one | 0.50% | |
| example 13 | PS | 0.50% | 4-methylene-1,3-dioxolan-2-one | 1.50% | 29% |
| | | | 4,5-dimethylene-1,3-dioxolan-2-one | 1.00% | |
| example 14 | PS | 1.00% | 4-methylene-1,3-dioxolan-2-one | 2.00% | 28% |
| | | | 4,5-dimethylene-1,3-dioxolan-2-one | 2.00% | |
| example 15 | PS | 0.50% | 4,5-dimethylene-1,3-dioxolan-2-one | 1.00% | 35% |
| example 16 | PS | 1.50% | 4,5-diethylene-1,3-dioxolan-2-one | 1.00% | 31% |
| example 17 | PS | 0.50% | 4-(3-fluoropropylene)-1,3-dioxolan-2- | 1.00% | 41% |
| | | | one | | |
| example 18 | PS | 0.50% | 4-fluoromethylene-1,3-dioxolan-2-one | 0.50% | 42% |
| example 19 | PS | 0.50% | 4,5-difluoromethylene-1,3-dioxolan-2- | 0.50% | 40% |
| | | | one | | |
| example 20 | PS | 1.00% | 4-fluoromethylene-1,3-dioxolan-2-one | 1.00% | 40% |
| example 21 | PS | 1.50% | 4-fluoromethylene-1,3-dioxolan-2-one | 3.00% | 34% |
| comparative | PS | / | / | / | 12% |
| example 1 | | | | | |
| comparative | PS | 2.00% | / | / | 16% |
| example 2 | | | | | |
| comparative | PS | / | 4-methylene-1,3-dioxolan-2-one | 2.00% | 21% |
| example 3 | | | | | |
| comparative | PS | 0.05% | 4-methylene-1,3-dioxolan-2-one | 0.05% | 19% |
| example 4 | | | | | |
| comparative | PS | 5.00% | 4-methylene-1,3-dioxolan-2-one | 5.00% | 7% |
| example 5 | | | | | |
| comparative | PS | 0.05% | 4-methylene-1,3-dioxolan-2-one | 1.00% | 20% |
| example 6 | | | | | |
| comparative | PS | 1.00% | 4-methylene-1,3-dioxolan-2-one | 5.00% | 12% |
| example 7 | | | | | |
| comparative | PS | 5.00% | 4-methylene-1,3-dioxolan-2-one | 1.50% | 10% |
| example 8 | | | | | |
| comparative | PS | 1.50% | 4-methylene-1,3-dioxolan-2-one | 0.05% | 14% |
| example 9 | | | | | |

As could be seen from the comparison among examples 1-21 and comparative example 1 (there was no additive, the low temperature discharging capacity retention rate was 12%): the lithium-ion secondary battery had a higher low temperature discharging capacity retention rate by adding a mixed additive of 1,3-propane sultone (PS) and 4-methylene-1,3-dioxolan-2-one and its derivatives and/or 4,5-dimethylene-1,3-dioxolan-2-one and its derivatives into the electrolyte of the lithium-ion secondary battery. This was because 4-methylene-1,3-dioxolan-2-one and its derivatives and/or 4,5-dimethylene-1,3-dioxolan-2-one and its derivatives had a higher reduction potential than 1,3-propane sultone (PS), the potential of the negative electrode plate was changed from high to low as formation charging, 4-methylene-1,3-dioxolan-2-one and its derivatives and/or 4,5-dimethylene-1,3-dioxolan-2-one and its derivatives preferentially formed a layer of SEI film with lower impedance on the surface of the negative electrode plate, then 1,3-propane sultone (PS) formed another SEI film on the above SEI film. In comparison with the SEI film which was formed on the surface of the negative electrode plate only by 4-methylene-1,3-dioxolan-2-one and its derivatives and/or 4,5-dimethylene-1,3-dioxolan-2-one and its derivatives, the composite SEI film which was formed by 1,3-propane sultone (PS) and 4-methylene-1,3-dioxolan-2-one and its derivatives and/or 4,5-dimethylene-1,3-dioxolan-2-one and its derivatives was more stable, which prevented further reduction reactions of 4-methylene-1,3-dioxolan-2-one and its derivatives and/or 4,5-dimethylene-1,3-dioxolan-2-one and its derivatives or 1,3-propane sultone (PS) on the surface of the negative electrode plate, and the formed SEI film was better for the lithium ion transfer in condition of low temperature, and the lithium-ion secondary battery had better low temperature discharging performance.

As could be seen from the comparison among comparative examples 1-9: there was no additive in comparative example 1, the lithium ion conductivity was lower, therefore the low temperature discharging capacity retention rate of the lithium-ion secondary battery was lower and was only 12%. As could be seen from the comparison between comparative example 2 and comparative example 3, when the electrolyte of the lithium-ion secondary battery only consisted of 1,3-propane sultone (PS), the formed SEI film was more compact, therefore the transfer performance of the lithium ions was worse and the low temperature discharging performance of the lithium-ion secondary battery was worse; when the electrolyte of the lithium-ion secondary battery only consisted of 4-methylene-1,3-dioxolan-2-one and its derivatives and/or 4,5-dimethylene-1,3-dioxolan-2-one and its derivatives, the stability of the formed SEI film was worse, and reduction reactions were continually generated on the surface of the negative electrode plate, therefore the formed SEI film was too thick and the low temperature discharging performance of the lithium-ion secondary battery was worse. As could be seen from the comparison among comparative examples 4-9, either the weight percentage of 1,3-propane sultone (PS) and/or 4-methylene-1,3-dioxolan-2-one was too low, the formed composite SEI film was not compact enough, the transfer performance of the lithium ions was worse, therefore the low temperature discharge capacity retention rate of the lithium-ion secondary battery was lower (comparative example 4, comparative example 6, comparative example 9); or the weight percentage of 1,3-propane sultone (PS) and/or 4-methylene-1,3-dioxolan-2-one was too high, the formed composite SEI film was too thick, thereby further reducing the low temperature discharging capacity retention rate of the lithium-ion secondary battery (comparative example 5, comparative example 7, comparative example 8).

As could be seen from the comparison among examples 1-5, when the weight percentage of 1,3-propane sultone (PS) was fixed to 0.3%, a compact composite SEI film which was good for lithium ion transfer could be formed by adding 0.3 wt %-4.0 wt % of 4-methylene-1,3-dioxolan-2-one. As the weight percentage of 4-methylene-1,3-dioxolan-2-one increased, the low temperature discharging capacity retention rate of the lithium-ion secondary battery firstly increased, when the weight percentage increased to 3.0%, the low temperature discharging capacity retention rate begun to decline, and when the weight percentage increased to 4.0%, the low temperature discharging capacity retention rate begun to decline by big amplitude, so when the weight percentage of 4-methylene-1,3-dioxolan-2-one was more than 3.0%, it was not good for the low temperature discharging capacity retention rate of the lithium-ion secondary battery.

A similar tendency could also be seen from the comparison among examples 6-11, when the weight percentage of 4,5-dimethylene-1,3-dioxolan-2-one was fixed to 0.5%, 0.3 wt % 4.0 wt % of 1,3-propane sultone (PS) was added. As the weight percentage of 1,3-propane sultone (PS) increased, the low temperature discharging capacity retention rate of the lithium-ion secondary battery firstly increased, when the weight percentage increased to 1.0%, the low temperature discharging capacity retention rate begun to decline, and when the weight percentage increased to 2.0%, the low temperature discharging capacity retention rate begun to decline by big amplitude, so when the weight percentage of the first additive 1,3-propane sultone (PS) was more than 2.0%, it was not good for the low temperature discharging capacity retention rate of the lithium-ion secondary battery.

As could be seen from the comparison among examples 12-17, a better compact composite SEI film which was good for lithium ion transfer was formed by adding 0.5 wt % 1.5 wt % of 1,3-propane sultone (PS) and 1.0 wt %-4.0 wt % of 4-methylene-1,3-dioxolan-2-one and its derivatives and/or 4,5-dimethylene-1,3-dioxolan-2-one and its derivatives, the low temperature discharging capacity retention rate of the lithium-ion secondary battery was all higher.

As could be seen from the comparison among examples 18-21, the low temperature discharging capacity retention rate of the lithium-ion secondary battery was better than that in examples 1-17 and comparative examples 1-9 as a whole, this might be because that F of the methylene of the second additive had a stronger electronegativity, 4-methylene-1,3-dioxolan-2-one and its derivatives or 4,5-dimethylene-1,3-dioxolan-2-one and its derivatives had a higher reduction potential, and also because of the fluoric configuration, the composite SEI film might have a better interface performance, therefore the lithium-ion secondary battery had better low temperature discharging performance.

In conclusion: when the weight percentage of the first additive in the electrolyte of the lithium-ion secondary battery was too low (<0.3%) or too high (>4.0%) and when the second additive in the electrolyte of the lithium-ion secondary battery was too low (<0.3%) or too high (>4.0%) in the electrolyte of the lithium-ion secondary battery, the compact composite SEI film with good interface performance could not be formed, and the lithium-ion secondary battery with better low temperature discharging performance could not be obtained. But when the electrolyte of the lithium-ion secondary battery consisted of 0.3 wt %-4.0 wt % of the first additive and 0.3 wt %-4.0 wt % of the second additive, preferably 0.5 wt %-2.0 wt % of the first additive and 0.5 wt %-3.0 wt % of the second additive, the lithium-ion secondary battery with better low temperature discharging performance could be obtained.

What is claimed is:

1. An electrolyte of a lithium-ion secondary battery, comprising:
a lithium salt;
a non-aqueous solvent; and
an additive;
the additive comprising a first additive and a second additive, the first additive being 1,3-propane sultone (PS), the second additive being 4-methylene-1,3-dioxolan-2-one and its derivatives with a structural formula 1 and/or 4,5-dimethylene-1,3-dioxolan-2-one and its derivatives with a structural formula 2; 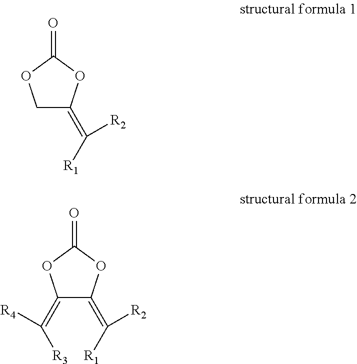
in the structural formula 1 and the structural formula 2, R₁, R₂, R₃ and R₄ each being hydrogen, halogen, C1˜C3 alkyl or halogenated alkyl;
a weight percentage of the first additive in the electrolyte of the lithium-ion secondary battery being 0.3%˜4.0%, a weight percentage of the second additive in the electrolyte of the lithium-ion secondary battery being 0.3%˜4.0%.

2. The electrolyte of the lithium-ion secondary battery according to claim 1, wherein the lithium salt comprises at least one of LiN(CₓF₂ₓ₊₁SO₂)(C_{y}F_{2y+1}SO₂) (where x, y is positive integer), LiPF₆, LiBF₄, LiBOB, LiAsF₆, Li(CF₃SO₂)₂N, LiCF₃SO₃ and LiClO₄.

3. The electrolyte of the lithium-ion secondary battery according to claim 1, wherein the non-aqueous solvent comprises a combination of a cyclic carbonate ester and a chain carbonate ester.

4. The electrolyte of the lithium-ion secondary battery according to claim 3, wherein
the cyclic carbonate ester comprises at least one of ethylene carbonate (EC), propylene carbonate (PC), γ-butyrolactone (GBL) and 2,3-butylene carbonate (BC);
the chain carbonate ester comprises at least one of dimethyl carbonate (DMC), diethyl carbonate (DEC), dipropyl carbonate (DPC), ethyl methyl carbonate (EMC), methyl propyl carbonate (MPC) and ethyl propyl carbonate (EPC).

5. The electrolyte of the lithium-ion secondary battery according to claim 3, wherein
a weight percentage of the cyclic carbonate ester in the electrolyte of the lithium-ion secondary battery is 10%˜70%;
a weight percentage of the chain carbonate ester in the electrolyte of the lithium-ion secondary battery is 15%˜80%.

6. The electrolyte of the lithium-ion secondary battery according to claim 1, wherein the weight percentage of the first additive in the electrolyte of the lithium-ion secondary battery is 0.5%˜2.0%.

7. The electrolyte of the lithium-ion secondary battery according to claim 1, wherein the weight percentage of the second additive in the electrolyte of the lithium-ion secondary battery is 0.5%˜3.0%.

8. The electrolyte of the lithium-ion secondary battery according to claim 1, wherein at least one of R₁ and R₂ is fluorine (F).

9. A lithium-ion secondary battery, comprising:
a positive electrode plate;
a negative electrode plate;
a separator interposed between the positive electrode plate and the negative electrode plate; and
an electrolyte, comprising:
a lithium salt;
a non-aqueous solvent; and
an additive;
the additive comprising a first additive and a second additive, the first additive being 1,3-propane sultone (PS), the second additive being 4-methylene-1,3-dioxolan-2-one and its derivatives with a structural formula 1 and/or 4,5-dimethylene-1,3-dioxolan-2-one and its derivatives with a structural formula 2; 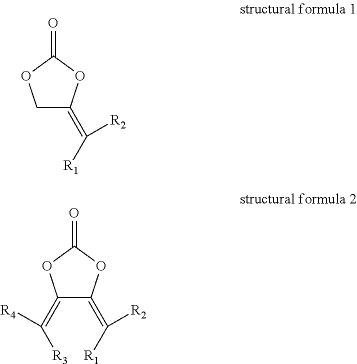
in the structural formula 1 and the structural formula 2, R₁, R₂, R₃ and R₄ each being hydrogen, halogen, C1˜C3 alkyl or halogenated alkyl;
a weight percentage of the first additive in the electrolyte of the lithium-ion secondary battery being 0.3%˜4.0%, a weight percentage of the second additive in the electrolyte of the lithium-ion secondary battery being 0.3%˜4.0%.

10. The lithium-ion secondary battery according to claim 9, wherein the lithium salt comprises at least one of LiN(CₓF₂ₓ₊₁SO₂)(C_{y}F_{2y+1}SO₂) (where x, y is positive integer), LiPF₆, LiBF₄, LiBOB, LiAsF₆, Li(CF₃SO₂)₂N, LiCF₃SO₃ and LiClO₄.

11. The lithium-ion secondary battery according to claim 9, wherein the non-aqueous solvent comprises a combination of a cyclic carbonate ester and a chain carbonate ester.

12. The lithium-ion secondary battery according to claim 11, wherein
the cyclic carbonate ester comprises at least one of ethylene carbonate (EC), propylene carbonate (PC), γ-butyrolactone (GBL) and 2,3-butylene carbonate (BC);
the chain carbonate ester comprises at least one of dimethyl carbonate (DMC), diethyl carbonate (DEC), dipropyl carbonate (DPC), ethyl methyl carbonate (EMC), methyl propyl carbonate (MPC) and ethyl propyl carbonate (EPC).

13. The lithium-ion secondary battery according to claim 11, wherein
a weight percentage of the cyclic carbonate ester in the electrolyte of the lithium-ion secondary battery is 10%˜70%;
a weight percentage of the chain carbonate ester in the electrolyte of the lithium-ion secondary battery is 15%˜80%.

14. The lithium-ion secondary battery according to claim 9, wherein the weight percentage of the first additive in the electrolyte of the lithium-ion secondary battery is 0.5%˜2.0%.

15. The lithium-ion secondary battery according to claim 9, wherein the weight percentage of the second additive in the electrolyte of the lithium-ion secondary battery is 0.5%˜3.0%.

16. The lithium-ion secondary battery according to claim 9, wherein at least one of R₁ and R₂ is fluorine (F).
